(19) United States
(12) Patent Application Publication
(10) Pub. No.: US 2021/0299885 A1
(43) Pub. Date: Sep. 30, 2021

(54) HUMAN-ROBOT COLLABORATION SYSTEM

(71) Applicant: J.Schmalz GmbH, Glatten (DE)

(72) Inventors: Walter Schaaf, Freudenstadt-Grüntal (DE); Harald Kuolt, Deilingen (DE)

(73) Assignee: J.Schmalz GmbH, Glatten (DE)

(21) Appl. No.: 17/214,025

(22) Filed: Mar. 26, 2021

(30) Foreign Application Priority Data
Mar. 27, 2020 (DE) 10 2020 108 513.3

(51) Int. Cl. B25J 13/02; B25J 13/08; B25J 9/10; B25J 9/16

(52) U.S. Cl. CPC B25J 13/02; B25J 9/1633; B25J 9/104; B25J 13/085

(57) ABSTRACT

The invention relates to a human-robot collaboration system including a robot having at least one manipulator, the at least one manipulator having an in particular terminal end portion, the HRC system includes a coupling device connected to the end portion of the at least one manipulator and at least one hand connection, it being possible to connect the at least one hand connection in a force-coupled manner to the end portion via the coupling device.

### CROSS REFERENCE TO RELATED APPLICATION

The present application relates and claims priority to German Patent Application No. DE 10 2020 108 513.3, filed Mar. 27, 2020, the entirety of which is hereby incorporated by reference.

### BACKGROUND

The invention relates to a human-robot collaboration system.

Such human-robot collaboration systems (HRC systems for short) allow humans and robots to work together in a common work area. While in the past the work areas of robots and humans have been preferably separated, there is an increasing effort to allow humans and robots to work more closely together (collaborate). Some processes can be carried out more efficiently if humans and robots work “hand in hand” and carry out certain work steps together. For this purpose, it is necessary that humans and robots not only share a work area, but may even touch each other for work-related reasons.

However, conventional industrial robot systems are not well suited for collaboration with humans, since the comparatively heavy industrial robots can develop high speeds and forces that pose a risk of injury to humans.

HRC systems of the type mentioned at the outset therefore comprise what are known as “collaborative robots” (“cobots”). In principle, such robots are designed to support an operator with actions. The robots can be equipped with an integrated sensor system for detecting a force and/or torque effect on the robot and can have force- and/or torque-controlled robot arms. Due to the integrated sensor system, such a robot can detect physical contact between a human and the robot arm and then control the robot arm depending on the forces detected. The robots are usually configured such that their robot arm yields to the action of a force, i.e. in particular gives way in the direction of introduction of a force. This can cause injury to people in contact with the robot. However, it is also conceivable that the robot carries out a movement pattern under program control.

In the known HRC systems, the robots are partly configured such that they follow preprogrammed movement paths or movement patterns with their robot arms (e.g. to repeatedly remove objects from a container and transfer them to an operator at a predetermined position). It is also known to control a linearly or rotationally articulated cantilever arm by means of a cable winch as required. For this purpose, “intelligent” gloves, for example, have been developed which are equipped with sensors and/or signal transmitters and are designed to generate signals based on user inputs or behavior and/or to detect a movement of an operator's hand and, for example, the cable winch to be controlled according to the hand movement (gesture control).

### SUMMARY OF THE INVENTION

The problem addressed by the present invention is that of simplifying and improving a human-robot collaboration, in particular to closely link a human and a robot with one another.

This problem is solved by a human-robot collaboration system.

The human-robot collaboration system (hereinafter “HRC system” for short) is designed in particular for person-guided (i.e. guided by an operator of the HRC system) handling of an object by means of a handling robot or with the support of a handling robot. One possible area of application is supporting an operator when transporting an object.

The HRC system comprises a robot having at least one manipulator, which is in particular motor-driven. The manipulator is configured to carry out, for example, program-controlled or force- and/or torque-controlled movements. The manipulator can be a robot arm, for example. The robot is designed, for example, such that a movement of the at least one manipulator can be controlled, in particular in a closed-loop manner, depending on a force and/or torque effect on the at least one manipulator. In particular, the robot is designed such that it moves the at least one manipulator in the direction in which a force exerted on the at least one manipulator is introduced. However, it is also conceivable that the manipulator carries out a predetermined movement pattern under program control, for example in such a way that a human operator is supported in handling an object.

In order to detect a force and/or torque effect on the at least one manipulator, the robot can have a correspondingly designed, integrated sensor device. The sensor device is preferably integrated into the manipulator or robot arm.

The at least one manipulator has an end portion, in particular at a free end. For example, a handling robot having a manipulator or robot arm can be used in which the end portion of the manipulator is designed in the usual way for connection to a handling tool. It is conceivable, for example, to use a conventional robot arm as a manipulator, with a terminal flange portion of the robot arm forming the end portion. For example, the flange portion can be a terminal tool flange.

The HRC system also comprises a coupling device connected to the end portion of the at least one manipulator. In addition, the HRC system comprises at least one hand connection for coupling to one hand of an operator, so that forces can be transmitted from the manipulator to the operator and/or from the operator to the manipulator.

In this respect, the hand connection represents a connecting device which allows the hand of an operator to be coupled to the end portion in order to transmit forces. The hand connection can be designed in various ways. For example, a design as a sleeve that surrounds the carpus and possibly also the wrist of the hand is conceivable. Such a sleeve can be flexible or rigid, at least in portions, as required. This can achieve both a good force coupling and the most comfortable wearing comfort possible.

Possible materials include textiles or plastics parts, for example produced using generative manufacturing techniques (in particular 3D printing). In particular, generative manufacturing techniques can be used to produce individually adapted hand connections, which for example have free-form surfaces that fit snugly against the hand of the operator. Surfaces can also be pierced individually at suitable points, for example to allow ventilation.

An advantageous embodiment for the hand connection is the shape of an operating glove. To this extent, this is designed to receive a hand of an operator, in particular in a form-fitting manner.

The at least one hand connection can be connected, in particular detachably connected, in a force-coupled manner to the end portion of the at least one manipulator via the coupling device. In this respect, forces and/or torques can be transmitted between the at least one hand connection and the at least one manipulator via the coupling device.

Such am embodiment allows an operator to “fuse” with the robot in a motorized manner: If the operator has coupled the hand connector (for example, he has put on the at least one operating glove), forces are transmitted to the manipulator coupled to the hand connection via the coupling device when the operator moves his hand.

Depending on the design, the robot can detect these forces by means of the integrated sensor device and—depending on these forces—control the at least one manipulator. The robot “senses,” so to speak, a movement of the operator's hand via the integrated sensor device and can move the at least one manipulator depending thereon. A movement of the at least one manipulator can in this respect be controlled directly via a movement of the operator's hand. The at least one manipulator is preferably force- and/or torque-controlled in such a way that, in the course of a force acting thereon, it moves in the direction in which the force is introduced. In this respect, the at least one manipulator can follow a hand movement of the operator. This not only allows particularly intuitive and ergonomic control of the robot, but rather the robot and operator merge to form a common movement group. However, it is also conceivable that the manipulator carries out a predefined, programmed movement pattern and supports the operator accordingly in an action to be carried out.

Such robot control allows, for example, a tool (e.g. a machining tool or a gripping tool) which is arranged on the at least one manipulator to approach a workpiece to be machined, guided by hand but nevertheless supported by the robot. In particular, such an HRC system can also be used to support an operator in handling and transporting an object.

For example, the operator can initially grasp an object using the at least one operating glove as with a normal work glove. The at least one operating glove can also offer a certain amount of protection when gripping. In particular, the at least one operating glove does not form any additional interfering contours which restrict the operator when gripping an object. When lifting the object, the robot can for example at least partially absorb the weight of the object and, for example, transfer it into the ground. In this respect, the weight for holding the object does not have to be applied by the operator himself. In other words, the operator's hand can act as an end effector for gripping the object, but the robot carries the load or part of the load. Because the at least one manipulator can follow a movement of the hand (see above), the operator can maneuver the object as usual. Overall, such an HRC system therefore makes it possible to maneuver an object in a way that does not harm the body but is nevertheless flexible.

It is particularly advantageous if the at least one manipulator is designed to be multi-articulated, in particular comprising a plurality of articulated links. The operator can then move the hand connection in preferably any movement paths in space, so that a movement with the hand connection is perceived by the operator as very “natural.” In particular, the robot is an HRC-compatible lightweight robot comprising at least one multi-articulated robot arm.

It is possible that a hand connection is provided for each manipulator. It is also possible for several, in particular two, hand connections to be arranged on a manipulator. An operator can then grip an object with two hands. In particular, it is also possible for the HRC system to comprise two manipulators, with a hand connection being provided on each manipulator. An operator can then move both hands independently of one another.

Because the sensor device integrated in the robot can be used to detect a force exerted by the operator on the manipulator, such an HRC system is comparatively inexpensive and compact. In particular, the at least one hand connection comprises no sensors and no control device. The at least one hand connection is in this respect designed in particular to be sensor-free and preferably also to be free of electronics, so to speak “without its own intelligence.” Such a hand connection is particularly robust and also inexpensive. It is therefore advantageously possible to have hand connections (for example operating gloves) that are individually adapted (for example with regard to size, material, intended use, etc.) for each employee at a comparatively low cost.

The HRC system can also comprise a control device, in particular a closed-loop control device, which is designed to control the robot. In particular, the control device is designed to control the robot such that the robot moves the at least one manipulator in the direction in which a force introduced into the at least one manipulator via the at least one hand connection is introduced. In this respect, the robot can in particular be controlled by means of the control device in such a way that the at least one manipulator follows a hand movement of the operator. In particular, the control device interacts with the integrated sensor device. However, the control device can also control according to a predetermined movement pattern.

The sensor device preferably comprises a plurality of force and/or torque sensors. In particular, the sensors act on joints and/or drive devices of the at least one manipulator and are preferably also arranged there.

The hand connection has in particular an opening for inserting a hand of the operator. If the hand connection is designed as an operating glove, it accordingly has a glove opening for inserting the hand. It is particularly advantageous if the hand connection or operating glove is designed such that when the hand connection is coupled to the coupling device, the opening or glove opening is stretched in such a way that an operator can insert a hand into the hand connection, in particular by a linear relative movement. This allows the operator to put the hand connector on and remove it again in a particularly simple and fast manner and thus to connect to the robot in a simple manner and to disconnect from it again if necessary, for example to be able to quickly leave the HRC system in an emergency situation. This is particularly advantageous in embodiments in which the at least one hand connection is rigidly connected to the at least one manipulator via the coupling device.

It is also possible for the coupling device to be designed in such a way that the at least one hand connection can be detachably coupled and decoupled and in particular coupled again to the end portion of the at least one manipulator. For example, it is conceivable that the coupling device comprises an interchangeable coupling, for example in the form of a clip connection. This allows an operator to e.g. “disengage” himself from the HRC system with the operating glove in a simple manner (for example, to perform work independently of the HRC system) and to “engage” again if necessary. Such a design makes it possible, in a simple and cost-effective manner, for each employee to have operating gloves that are individually adapted to him and to be able to connect to the HRC system via the interchangeable coupling. In particular, the interchangeable coupling does not have to withstand any great forces, since the robot can be controlled via correspondingly force-sensitive sensors. The interchangeable coupling can therefore be designed to be easy and comfortable to operate.

It is possible for the hand connection and the manipulator to be rigidly connected to one another, i.e. in particular that the hand connection cannot be moved or can be moved only to a limited extent relative to the manipulator. This promotes precise positioning, for example.

However, it is also possible that the coupling device comprises a cable connection. In particular, the cable connection comprises at least one suspension cable which connects the at least one hand connection to the end portion of the at least one manipulator. Such a design makes it possible to move the hand connection relative to the manipulator within certain limits. There is thus a certain radius of action even when the manipulator is in a fixed position, which makes handling easier. For example, in such a design having a cable connection, it is not absolutely necessary to place the at least one manipulator in a precise position relative to an object in order to be able to lift this object.

In the context of an advantageous embodiment of the HRC system, the cable connection can comprise two suspension cables, each suspension cable being connected or connectable to a hand connection and the two suspension cables being connected to the same end portion of the at least one manipulator via a deflection device. The operator can then grip an object with two hands. At the same time, the cable connection provides a certain freedom of movement, so that objects of different sizes can also be gripped and maneuvered flexibly.

### BRIEF DESCRIPTION OF THE DRAWINGS

The invention will be explained in more detail in the following with reference to the drawings.

In the drawings:

FIG. 1 is a simplified sketched illustration of an HRC system in a first embodiment; and

FIG. 2 is a simplified sketched illustration of an HRC system in a second embodiment.

In the following description and in the drawings, the same reference signs are used for identical or corresponding features.

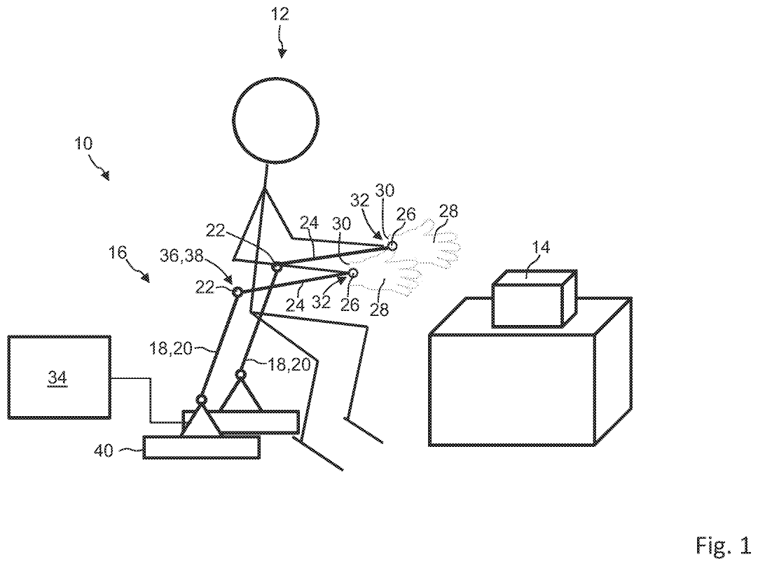

FIG. 1 shows, in a simplified sketched illustration, a first embodiment of an HRC system, which is denoted as a whole by the reference number 10. In the example shown, the HRC system 10 is designed in particular to support an operator 12 when transporting an object 14.

### DETAILED DESCRIPTION

The HRC system 10 comprises a robot 16 which, in the example shown, has two manipulators 18 (shown schematically in FIG. 1). By way of example and preferably, the robot 16 is a lightweight robot having two robot arms. Each manipulator 18 comprises a plurality of links 20 which are movably connected to one another via joints 22. The manipulators 18 each have a terminal end portion 26 on the last link 24 thereof (explained in more detail below). The end portion is, for example, a flange portion which is suitable for connection to a handling tool.

The HRC system 10 also comprises two hand connections 28. The hand connections are designed, for example, as operating gloves which each have an opening (here: glove opening 30) for inserting a hand of the operator 12. By way of example, the operating gloves 28 are designed as finger gloves. The hand connection 28 can, however, also have other shapes, for example in the form of a sleeve for the carpus and/or the wrist of an operator. The operating gloves 28 are each connected in a force-coupled manner to the end portion 26 of a manipulator 18 via a coupling device 32, so that forces and torques can be transmitted between the operating glove 28 and the corresponding manipulator 18.

It is possible for the operating gloves 28 to be rigidly connected to the end portion 26 of the particular manipulator 18. It is also possible for the operating gloves 28 to be detachably coupled and uncoupled and coupled again to each end portion 26 via the coupling device 32, for example via a correspondingly designed interchangeable coupling.

The manipulators 18 of the robot 16 are force- and/or torque-controlled, for example. For this purpose, the HRC system 10 can have a control device 34 which is designed to control the robot 16 depending on a force or torque acting on the manipulators 18. By way of example and preferably, the control device 34 is designed such that it controls the robot 16 in such a way that the robot 16 moves each manipulator 18 in the direction in which a force introduced into the particular manipulator 18 is introduced.

In order to detect a force or torque effect on the particular manipulator 18, the robot 16 has an integrated sensor device 36 which interacts with the control device 34. The sensor device 36 has a plurality of force and/or torque sensors 38, which are designed to detect a force and/or torque effect on the particular manipulator 18. By way of example and preferably, the sensors 38 act on the joints 22 of the manipulators 18 and are preferably also arranged there.

In order to handle an object 14, the operator can first grasp the object 14 by means of the operating gloves 28 as usual. When the object 14 is lifted, the robot 16 then at least partially absorbs the weight of the object 14 and transfers it into the floor 40, so that the operator 12 himself only has to carry a small load. In order to maneuver the object 14 (for example to transport the object 14 to a different position), the operator 12 only has to move the object 14 as usual. In this case, forces are transmitted via the operating glove 28 and the coupling device 32 to the manipulator 18 connected to the operating glove 28, which forces are detected by the sensors 38 of the integrated sensor device 36. The control device 34 then controls the robot 16 depending on the detected force or torque effect in such a way that it moves the manipulator 18 coupled to the operating glove 28 in the direction in which the force is introduced. In this respect, the manipulator 18 follows a hand movement of the operator 12.

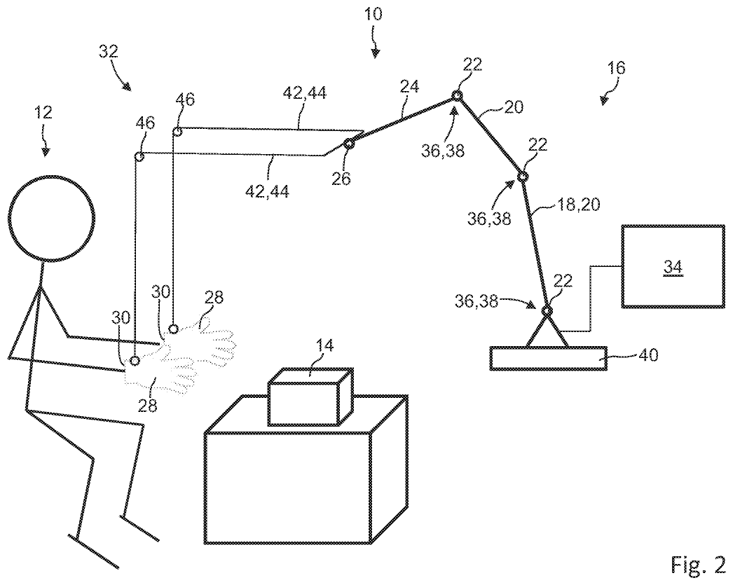

FIG. 2 shows a further embodiment of an HRC system 10, comprising a robot 16 having a multi-articulated manipulator 18.

As shown schematically in simplified form in FIG. 2, the operating gloves 28 are connected to an end portion 26 of the manipulator 18 via a cable connection 42. In the example shown, the cable connection 42 comprises two suspension cables 44, each suspension cable 44 being connected to an operating glove 28. The suspension cables 44 are connected to the end portion 26 of the manipulator 18 via a deflection device 46.

Otherwise, the HRC system 10 according to FIG. 2 corresponds in design and mode of operation to the embodiment of the HRC system 10 described with reference to FIG. 1.

1. A Human-robot collaboration (HRC) system for supporting an operator when transporting an object, comprising
a robot having at least one drivable robot arm with an end portion and
a sensor device integrated into the robot arm for detecting a force and/or torque effect on the at least one robot arm,
wherein the HRC system comprises a coupling device connected to the end portion of the at least one robot arm and at least one hand connection for coupling to a hand of an operator, wherein the at least one hand connection can be connected in a force-coupled manner to the end portion via the coupling device.

2. The HRC system according to claim 1, wherein the hand connection is designed as an operating glove for receiving a hand of an operator of the HRC system.

3. The HRC system according to claim 1, wherein the at least one hand connection comprises no sensors and no control device.

4. The HRC system according to claim 1, further comprising a control device which interacts with the sensor device and is designed to control the robot.

5. The HRC system according to claim 1, wherein the sensor device comprises a plurality of force and/or torque sensors.

6. The HRC system according to claim 1, wherein the at least one hand connection has an opening for inserting a hand of the operator, wherein the hand connection is designed such that when the hand connection is coupled to the coupling device, the opening is stretched in such a way that an operator can insert a hand into the hand connection.

7. The HRC system according to claim 1, wherein the coupling device is designed such that the at least one hand connection can be detachably coupled to the end portion of the at least one robot arm.

8. The HRC system according to claim 1, wherein the coupling device comprises a cable connection, wherein the cable connection comprises at least one suspension cable which connects the at least one hand connection to the end portion of at least one robot arm.

9. The HRC system according to claim 8, wherein the cable connection comprises two suspension cables, wherein each suspension cable is connected to a hand connection and wherein the two suspension cables are connected to the end portion of the at least one robot arm via a deflection device.
